(19) United States
(12) Patent Application Publication
(10) Pub. No.: US 2013/0165353 A1
(43) Pub. Date: Jun. 27, 2013

(54) STABLE SUSPENSIONS OF CARBON NANOPARTICLES FOR NANO-ENHANCED PDC, LBL COATINGS, AND COOLANTS

(71) Applicants: Oleg A. Mazyar, Houston, TX (US); Michael H. Johnson, Katy, TX (US); Soma Chakraborty, Houston, TX (US); Gaurav Agrawal, Aurura, CO (US)

(72) Inventors: Oleg A. Mazyar, Houston, TX (US); Michael H. Johnson, Katy, TX (US); Soma Chakraborty, Houston, TX (US); Gaurav Agrawal, Aurura, CO (US)

(73) Assignee: BAKER HUGHES INCORPORATED, Houston, TX (US)

(21) Appl. No.: 13/332,432

(22) Filed: Dec. 21, 2011

(51) Int. Cl. C09K 8/00; B82Y 30/00

(52) U.S. Cl. 507/219; 977/773; 977/746; 977/734; 977/762

(57) ABSTRACT

A nanocomposite comprises a matrix; and a nanoparticle comprising an ionic polymer disposed on the surface of the nanoparticle, the nanoparticle being dispersed in and/or disposed on the matrix. A method of making a nanocomposite, comprises combining a nanoparticle and an ionic liquid; polymerizing the ionic liquid to form an ionic polymer; disposing the ionic polymer on the nanoparticle; and combining the nanoparticle with the ionic polymer and a matrix to form the nanocomposite.

### BACKGROUND

Fluid production from a downhole environment is a complex, multi-step endeavor. A borehole must be drilled, which requires various tools, and specialized equipment and fluids must be run downhole to establish fluid communication pathways to the surface. Drilling creates a great amount of heat, and the borehole or other subterranean region can be a harsh environment for many materials, including those used for the equipment and fluids. Extreme heat, high differential pressures, chemical attack, and other factors can lead to deterioration and failure of such materials.

Coolants are used for cooling drilling equipment and heat management, and tools made of high-strength materials can be constructed with sealant for additional protection. Materials and methods improving the reliability and long-term performance of equipment downhole would be well-received in the art.

### BRIEF DESCRIPTION

The above and other deficiencies of the prior art are overcome by, in an embodiment, a nanocomposite comprising a matrix; and a nanoparticle comprising an ionic polymer disposed on the surface of the nanoparticle, the nanoparticle being dispersed in and/or disposed on the matrix.

In another embodiment, a method of making a nanocomposite, comprises combining a nanoparticle and an ionic liquid; polymerizing the ionic liquid to form an ionic polymer; disposing the ionic polymer on the nanoparticle; and combining the nanoparticle with the ionic polymer and a matrix to form the nanocomposite.

### BRIEF DESCRIPTION OF THE DRAWINGS

The following descriptions should not be considered limiting in any way. With reference to the accompanying drawings, like elements are numbered alike:

FIG. 1 shows an ionic polymer disposed on a nanoparticle, which is dispersed among a hydrophilic molecule and a hydrophobic molecule;

FIG. 2 shows a cross-section of a layer-by-layer coating;

FIG. 3 shows a cross-section of a layer-by-layer-coating with two binding layers; and

FIG. 4 shows a cross-section of a layer-by-layer coating with ionic polymer coated nanoparticles disposed among a polyanion and polycation.

### DETAILED DESCRIPTION

A detailed description of one or more embodiments of the disclosed article and method are presented herein by way of exemplification and not limitation with reference to the Figures.

It has been discovered that nanocomposite compositions useful in downhole fluids and articles can be even more robust with the inclusion of an ionic polymer covered nanoparticle. Moreover, Coulombic effects due to the surface charge of such nanoparticles provide a high degree of dispersability of the nanoparticles with concomitant enhancement of material properties.

In an embodiment, a nanocomposite includes a matrix and a nanoparticle having an ionic polymer disposed on the surface of the nanoparticle. The matrix can be various materials as described below with respect to applications of the nanocomposite. Briefly, the nanoparticle is dispersed in the matrix. Alternatively or in addition, the nanoparticle can be disposed on the matrix.

Nanoparticles, from which the nanocomposite is formed, are generally particles having an average particle size, in at least one dimension, of less than one micrometer (μm). As used herein “average particle size” refers to the number average particle size based on the largest linear dimension of the particle (sometimes referred to as “diameter”). Particle size, including average, maximum, and minimum particle sizes, can be determined by an appropriate method of sizing particles such as, for example, static or dynamic light scattering (SLS or DLS) using a laser light source. Nanoparticles include both particles having an average particle size of 250 nanometers (nm) or less, and particles having an average particle size of greater than 250 nm to less than 1 μm (sometimes referred in the art as “sub-micron sized” particles). In an embodiment, a nanoparticle has an average particle size of about 0.05 nm to about 500 nm, in another embodiment, 0.1 nm to 250 nm, in another embodiment, about 0.1 nm to about 150 nm, and in another embodiment about 1 nm to about 75 nm. The nanoparticles are monodisperse, where all particles are of the same size with little variation, or polydisperse, where the particles have a range of sizes and are averaged. Generally, polydisperse nanoparticles are used. In another embodiment, nanoparticles of different average particle sizes are used, and in this way, the particle size distribution of the nanoparticles is unimodal (exhibiting a single distribution), bimodal exhibiting two distributions, or multi-modal, exhibiting more than one particle size distribution.

The minimum particle size for the smallest 5 percent of the nanoparticles is less than 1 nm, in an embodiment less than or equal to 0.8 nm, and in another embodiment less than or equal to 0.5 nm. Similarly, the maximum particle size for 95% of the nanoparticles is greater than or equal to 900 nm, in an embodiment greater than or equal to 750 nm, and in another embodiment greater than or equal to 500 nm.

The nanoparticles have a high surface area of greater than 180 m²/g, in an embodiment, 300 m²/g to 1800 m²/g, and in another embodiment 500 m²/g to 1500 m²/g.

The nanoparticles used to form nanocomposite include fullerenes, nanotubes, nanographite, nanodots, nanorods, graphene including nanographene and graphene fiber, nanodiamonds, polysilsesquioxanes, inorganic nanoparticles including silica nanoparticles, nanoclays, metal, metal oxides, metal or metalloid nitrides, or combinations comprising at least one of the foregoing.

Fullerenes, as disclosed herein, include any of the known cage-like hollow allotropic forms of carbon possessing a polyhedral structure. Fullerenes include, for example, those having from about 20 to about 100 carbon atoms. For example, C60 is a fullerene having 60 carbon atoms and high symmetry (D₅ₕ), and is a relatively common, commercially available fullerene. Exemplary fullerenes include C30, C32, C34, C38, C40, C42, C44, C46, C48, C50, C52, C60, C70, C76, and the like.

Nanotubes include carbon nanotubes, inorganic nanotubes (e.g., boron nitride nanotubes), metallated nanotubes, or a combination comprising at least one of the foregoing. Nanotubes are tubular fullerene-like structures having open or closed ends and which are inorganic (e.g., boron nitride) or made entirely or partially of carbon. In an embodiment, carbon and inorganic nanotubes include additional components such as metals or metalloids, which are incorporated into the structure of the nanotube, included as a dopant, form a surface coating, or a combination comprising at least one of the foregoing. Nanotubes, including carbon and inorganic nanotubes, are single walled nanotubes (SWNTs) or multi-walled nanotubes (MWNTs).

Nanographite is a cluster of plate-like sheets of graphite, in which a stacked structure of one or more layers of graphite, which has a plate-like two-dimensional structure of fused hexagonal rings with an extended delocalized π-electron system, are layered and weakly bonded to one another through it-π stacking interaction. Nanographite has both micro- and nano-scale dimensions, such as for example an average particle size of 1 to 20 μm, in an embodiment 1 to 15 μm, and an average thickness (smallest) dimension in nano-scale dimensions, and an average thickness of less than 1 μm, in an embodiment less than or equal to 700 nm, and in another embodiment less than or equal to 500 nm.

In an embodiment, the nanoparticle is graphene including nanographene and graphene fibers (i.e., graphene particles having an average largest dimension of greater than 1 μm, a second dimension of less than 1 μm, and an aspect ratio of greater than 10, where the graphene particles form an interbonded chain). Graphene and nanographene, as disclosed herein, are effectively two-dimensional particles of nominal thickness, having of one, or more than one layers of fused hexagonal rings with an extended delocalized it-electron system; as with nanographite, where more than one graphene layer is present, the layers are weakly bonded to one another through π-π stacking interaction. Graphene in general, and including nanographene (with an average particle size of less than 1 μm), is thus a single sheet or a stack of several sheets having both micro- and nano-scale dimensions. In some embodiments, graphene has an average particle size of 1 to 20 μm, in another embodiment 1 to 15 μm, and an average thickness (smallest) dimension in nano-scale dimensions of less than or equal to 50 nm, in an embodiment less than or equal to 25 nm, and in another embodiment less than or equal to 10 nm. An exemplary graphene has an average particle size of 1 to 5 μm, and in an embodiment 2 to 4 μm. In another embodiment, smaller nanoparticles or sub-micron sized particles as defined above are combined with nanoparticles having an average particle size of greater than or equal to 1 μm. In a specific embodiment, the nanoparticle is a derivatized graphene.

Graphene, including nanographene, is prepared by, for example, exfoliation of nanographite or by a synthetic procedure by “unzipping” a nanotube to form a nanographene ribbon, followed by derivatization of the nanographene to prepare nanographene oxide.

Exfoliation to form graphene or nanographene is carried out by exfoliation of a graphite source such as graphite, intercalated graphite, and nanographite. Exemplary exfoliation methods include, but are not limited to, those practiced in the art such as fluorination, acid intercalation, acid intercalation followed by high temperature treatment, and the like, or a combination comprising at least one of the foregoing. Exfoliation of the nanographite provides a nanographene having fewer layers than non-exfoliated nanographite. It will be appreciated that exfoliation of nanographite may provide the nanographene as a single sheet only one molecule thick, or as a layered stack of relatively few sheets. In an embodiment, exfoliated nanographene has fewer than 50 single sheet layers, in an embodiment fewer than 20 single sheet layers, in another embodiment fewer than 10 single sheet layers, and in another embodiment fewer than 5 single sheet layers.

A nanodiamond is a diamond particle having an average particle size of less than 1 μm. Nanodiamonds are from a naturally occurring source, such as a by-product of milling or other processing of natural diamonds, or are synthetic, prepared by any suitable commercial method. Nanodiamonds are used as received, or are sorted and cleaned by various methods to remove contaminants and non-diamond carbon phases present, such as residues of amorphous carbon or graphite.

Polysilsesquioxanes, also referred to as polyorganosilsesquioxanes or polyhedral oligomeric silsesquioxanes (POSS) derivatives are polyorganosilicon oxide compounds of general formula RSiO_{1.5} (where R is an organic group such as methyl) having defined closed or open cage structures (closo or nido structures). Polysilsesquioxanes, including POSS structures, may be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

Nanoclays are hydrated or anhydrous silicate, plate-like minerals with a layered structure and include, for example, alumino-silicate clays such as kaolins including vermicullite, hallyosite, smectites including montmorillonite, saponite, beidellite, nontrite, hectorite, illite, and the like. Exemplary nanoclays include those marketed under the tradename CLOISITE® marketed by Southern Clay Additives, Inc. Nanoclays are exfoliated to separate individual sheets, or are non-exfoliated, and further, are dehydrated or included as hydrated minerals. Other nano-sized mineral fillers of similar structure are also included such as, for example, talc, micas including muscovite, phlogopite, or phengite, or the like. Platelets of the nanoclay generally have a thickness of about 3 to about 1000 Angstroms and a size in the planar direction ranging from about 0.01 μm to 100 μm. The aspect ratio (length versus thickness) is generally in the order of about 10 to about 10,000.

Inorganic nanoparticles include a metal or metalloid oxide such as silica, alumina, titania, tungsten oxide, iron oxides, combinations thereof, or the like; a metal or metalloid carbide such as tungsten carbide, silicon carbide, boron carbide, or the like; a metal or metalloid nitride such as titanium nitride, boron nitride, silicon nitride, or the like; or a combination comprising at least one of the foregoing.

Metal nanoparticles include those made from metals including alkali metal, an alkaline earth metal, an inner transition metal (a lanthanide or actinide), a transition metal, or a post-transition metal. Examples of such metals include magnesium, aluminum, iron, tin, titanium, platinum, palladium, cobalt, nickel, vanadium, chromium, manganese, cobalt, nickel, zirconium, ruthenium, hafnium, tantalum, tungsten, rhenium, osmium, alloys thereof, or a combination comprising at least one of the foregoing. In other embodiments, inorganic nanoparticles include those coated with one or more layers of metals such as iron, tin, titanium, platinum, palladium, cobalt, nickel, vanadium, alloys thereof, or a combination comprising at least one of the foregoing.

Nanoparticles in general can be derivatized to include a variety of different functional groups such as, for example, carboxy (e.g., carboxylic acid groups), epoxy, ether, ketone, amine, hydroxy, alkoxy, alkyl, aryl, aralkyl, alkaryl, lactone, functionalized polymeric or oligomeric groups, and the like. In an embodiment, the nanoparticles include a combination of derivatized nanoparticles and underivatized nanoparticles.

According to an embodiment, the nanoparticle is derivatized to include with a functional group that is hydrophilic, hydrophobic, oxophilic, lipophilic, or oleophilic to provide a balance of desirable properties.

In an exemplary embodiment, the nanoparticle is derivatized by, for example, amination to include amine groups, where amination may be accomplished by nitration followed by reduction, or by nucleophilic substitution of a leaving group by an amine, substituted amine, or protected amine, followed by deprotection as necessary. In another embodiment, the nanoparticle is derivatized by oxidative methods to produce an epoxy, hydroxy group or glycol group using a peroxide, or by cleavage of a double bond by for example a metal mediated oxidation such as a permanganate oxidation to form ketone, aldehyde, or carboxylic acid functional groups.

Where the functional groups are alkyl, aryl, aralkyl, alkaryl, functionalized polymeric or oligomeric groups, or a combination of these groups, the functional groups are attached through intermediate functional groups (e.g., carboxy, amino) or directly to the derivatized nanoparticle by: a carbon-carbon bond without intervening heteroatoms, to provide greater thermal and/or chemical stability to the derivatized nanoparticle, as well as a more efficient synthetic process requiring fewer steps; by a carbon-oxygen bond (where the nanoparticle contains an oxygen-containing functional group such as hydroxy or carboxylic acid); or by a carbon-nitrogen bond (where the nanoparticle contains a nitrogen-containing functional group such as amine or amide). In an embodiment, the nanoparticle can be derivatized by metal mediated reaction with a C6-30 aryl or C7-30 aralkyl halide (F, Cl, Br, I) in a carbon-carbon bond forming step, such as by a palladium-mediated reaction such as the Stille reaction, Suzuki coupling, or diazo coupling, or by an organocopper coupling reaction.

In another embodiment, a nanoparticle, such as a fullerene, nanotube, nanodiamond, or nanographene, is directly metallated by reaction with e.g., an alkali metal such as lithium, sodium, or potassium, followed by reaction with a C1-30 alkyl or C7-30 alkaryl compound with a leaving group such as a halide (Cl, Br, I) or other leaving group (e.g., tosylate, mesylate, etc.) in a carbon-carbon bond forming step. The aryl or aralkyl halide, or the alkyl or alkaryl compound, may be substituted with a functional group such as hydroxy, carboxy, ether, or the like. Exemplary groups include, for example, hydroxy groups, carboxylic acid groups, alkyl groups such as methyl, ethyl, propyl, butyl, pentyl, hexyl, octyl, dodecyl, octadecyl, and the like; aryl groups including phenyl and hydroxyphenyl; alkaryl groups such as benzyl groups attached via the aryl portion, such as in a 4-methylphenyl, 4-hydroxymethylphenyl, or 4-(2-hydroxyethyl)phenyl (also referred to as a phenethylalcohol) group, or the like, or aralkyl groups attached at the benzylic (alkyl) position such as found in a phenylmethyl or 4-hydroxyphenyl methyl group, at the 2-position in a phenethyl or 4-hydroxyphenethyl group, or the like. In an exemplary embodiment, the derivatized nanoparticle is nanographene substituted with a benzyl, 4-hydroxybenzyl, phenethyl, 4-hydroxyphenethyl, 4-hydroxymethylphenyl, or 4-(2-hydroxyethyl)phenyl group or a combination comprising at least one of the foregoing groups.

In another embodiment, the nanoparticle is further derivatized by grafting certain polymer chains to the functional groups. For example, polymer chains such as acrylic chains having carboxylic acid functional groups, hydroxy functional groups, and/or amine functional groups; polyamines such as polyethyleneamine or polyethyleneimine; and poly(alkylene glycols) such as poly(ethylene glycol) and poly(propylene glycol), may be included by reaction with functional groups.

Where the nanoparticle is a carbon-based nanoparticle such as nanographene, a carbon nanotube, nanodiamond, or the like, the degree of functionalization varies from 1 functional group for every 5 carbon centers to 1 functional group for every 100 carbon centers, depending on the functional group, and the method of functionalization.

In an embodiment, the nanoparticle has an ionic polymer disposed on the surface of the nanoparticle. The ionic polymer is a reaction product of an ionic liquid which includes a cation and an anion. The reaction that produces the reaction product is, for example, polymerization of monomers of the ionic liquid. Ionic liquids are liquids that are almost exclusively ions. Ionic liquids differ from so-called molten salts in that molten salts are typically corrosive and require extremely high temperatures to form a liquid due to ionic bond energies between the ions in the salt lattice. For example, the melting temperature of the face-centered cubic crystal sodium chloride is greater than 800° C. In comparison, many ionic liquids are liquid below 100° C.

According to an embodiment, the ionic liquid has a cation of formula (1) to formula (14):

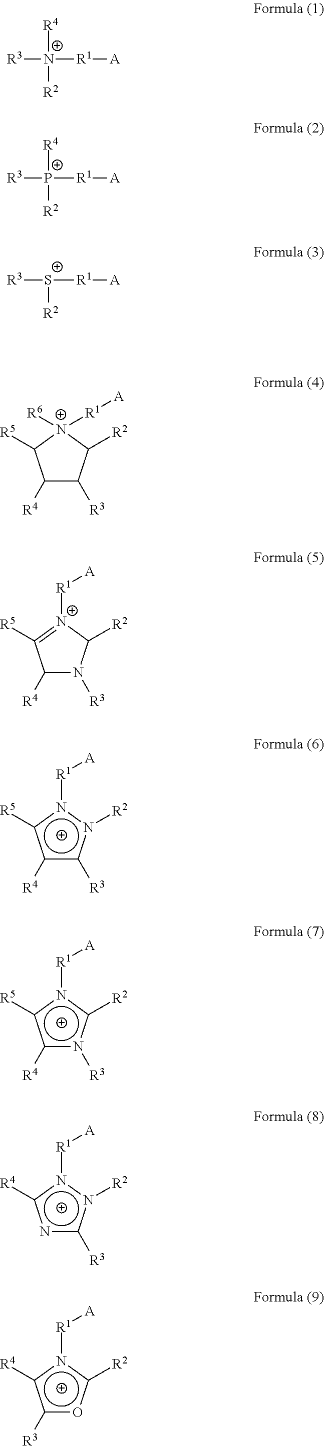

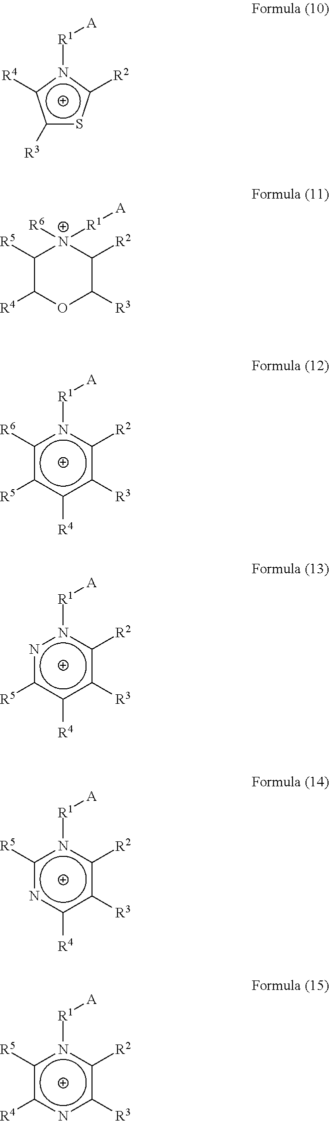

wherein A is a polymerizable group; R¹ is a bond (e.g., a single bond, double bond, and the like) or any biradical group such as alkylene, alkyleneoxy, cycloalkylene, alkenylene, alkynylene, arylene, aralkylene, aryleneoxy, which is unsubstituted or substituted with a heteroatom or halogen; R², R³, R⁴, R⁵, and R⁶ are independently hydrogen, alkyl, alkyloxy, cylcloalkyl, aryl, alkaryl, aralkyl, aryloxy, aralkyloxy, alkenyl, alkynyl, amine, alkyleneamine, aryleneamine, hydroxy, carboxylic acid group or salt, halogen, which is unsubstituted or substituted with a heteroatom or halogen.

In an embodiment, the polymerizable group A includes an α,β-unsaturated carbonyl group (e.g., an acryl group or methacryl group), α,β-unsaturated nitrile group, alkenyl group (e.g., a conjugated dienyl group), alkynyl group, vinyl carboxylate ester group, carboxyl group, carbonyl group, epoxy group, isocyanate group, hydroxyl group, amide group, amino group, ester group, formyl group, nitrile group, nitro group, or a combination comprising at least one of the foregoing.

According to an embodiment, the cation of the ionic liquid includes imidazolium, pyrazolium, pyridinium, ammonium, pyrrolidinium, sulfonium, phosphonium, morpholinium, derivatives thereof, or a combination comprising at least one of the foregoing.

The anion of the liquid ion is not particularly limited as long as the anion does not interfere with polymerization of the ionic liquid or dispersal of the nanoparticles. Non-limiting examples of the anion are halide (e.g., fluoride, chloride, bromide, iodide), tetrachloroaluminate (AlCl₄⁻), hexafluorophosphate (PF₆⁻), hexafluoroarsenate (AsF₆⁻), tetrafluroborate (BE₄⁻), triflate (CF₃SO₃⁻), mesylate (CH₃SO₃⁻), dicyanamide ((NC)₂N⁻), thiocyanate (SCN⁻), alkylsulfate (ROSO₃⁻, where R is a halogentated or non-halogenated linear or branched alkyl group, e.g., CH₃CH₂OSO₃⁻), tosylate, bis(trifluoromethyl-sulfonyl)imide, alkyl sulfate (ROSO₃⁻, where R is a halogentated or non-halogenated linear or branched alkyl group, e.g., CF₂HCH₂OSO₃⁻), alkyl carbonate (ROCO₂⁻, where R is a halogentated or non-halogenated linear or branched alkyl group), or a combination comprising at least one of the foregoing.

In a specific embodiment, the ionic liquid has a cation of formula 7 with A being an alkenyl group, R1 being a bond or bivalent radical, and R2 to R5 being an alkyl group or hydrogen; and an anion that is tetrafluoroborate. Particularly, the ionic liquid has a cation of formula 7 with A being an alkenyl group, R1 being a bond or bivalent radical, R3 being an alkyl group, and R2, R4, and R5 being hydrogen; and an anion that is tetrafluoroborate.

Examples of the ionic liquid include but are not limited to 3-ethyl-1-vinylimidazlium tetrafluoroborate, 1-methyl-3-vinylimidazolium methyl carbonate, 1-isobutenyl-3-methylimidazolium tetrafluoroborate, 1-allyl-3-methylimidazolium bis(trifluoromethylsulfonyl)imide, 1-allyl-3-methylimidazolium bromide, 1,3-bis(cyanomethyl)imidazolium bis(trifluoromethylsulfonyl)imide, 1-ethyl-nicotinic acid ethyl ester ethylsulfate, 1-butyl-nicotinic acid butyl ester bis[(trifluoromethyl)sulfonyl]imide, 1-(3-cyanopropyl)-3-methylimidazolium bis(trifluoromethylsulfonyl)amide, 1,3-diallylimidazolium bis(trifluoromethylsulfonyl)imide, ethyl-dimethyl-(cyanomethyl)ammonium bis(trifluoromethylsulfonyl)imide, 3-[4-(acryloyloxy)butyl]-1-methyl-1H-imidazol-3-ium hexafluorophosphate, 1-methyl-3-{3 -[(2-methylacryloyl)oxy]propyl{-1H-imidazol-3-ium bromide, and 3 -ethenyl-1-ethyl-1H-imidazol-3-ium bis(trifluoromethylsulfonyl)imide. Combinations of the ionic liquid can be used to form an ionic polymer on the nanoparticle.

The ionic liquids can be obtained commercially, for example, from Sigma Aldrich, or can be synthetically prepared. Exemplary syntheses include reacting an alkyl tertiary amine having a polymerizable group with an alkyl halide to obtain quaternarization of a nitrogen then performing an exchange reaction with a desired anion. Alternatively, by reacting, for example, a tertiary amine with methyl p-tosylate, the anion can be concurrently introduced with quaternarization. A further alternative synthesis includes, for example, reacting a compound such as 2-chloroethanol with an N-alkylimidazole or pyridine to form an imidazolium salt or a pyridinium salt, reacting the salt with (meth)acryloyl chloride, and peforming an exchange reaction with a desired anion. Yet another alternative is reacting an N-alkylimidazole or pyridine with 2-((meth)acryloylethyl)chloride and then carrying out an exchange reaction with a desired anion.

According to an embodiment, a method of making a nanocomposite includes combining a nanoparticle and an ionic liquid; polymerizing the ionic liquid to form an ionic polymer; disposing the ionic polymer on the nanoparticle; and combining the nanoparticle with the ionic polymer and a matrix to form the nanocomposite.

The ionic liquid is combined with nanoparticles, and the ionic liquid is subjected to a thermally initiated, free radical polymerization. In an embodiment, an ionic liquid monomer, for example, 3-ethyl-1 -vinylimidazolium tetrafluoroborate, forms an ionic liquid polymer on the surface of the nanoparticle. As a result, the nanoparticle is functionalized with charged groups from the ionic liquid monomer. These surface functional groups can be uniformly distributed on the surface of the nanoparticle, or alternatively, can be non-uniformly distributed thereon. Thus, an ionic liquid polymer film is formed on the surface of the nanoparticle.

Although free radical polymerization is specifically mentioned, the polymerization reaction is not limited thereto, and other polymerization reactions can be used to form the ionic polymer from the ionic liquid. Other polymerization reactions include cationic chain growth polymerization, step-reaction polymerization, condensation polymerization, and the like.

Additionally, more one than one type of ionic liquid and/or nanoparticle can be used in forming the ionic polymer disposed on the nanoparticle. In an embodiment, the ionic liquid contains ionic liquids of formula 7 and formula 13, and the nanoparticles are carbon nanotubes and nanodiamonds.

In one, non-limiting embodiment, the nanoparticles are derivatized with a functional group as described above, and then subjected to further functionalization due to the polymerization of the ionic liquid forming an ionic liquid polymer on the nanoparticle. In an embodiment, the nanoparticles may contain layers of material (such as carbon coated metal nanoparticles used in polycrystalline diamond composite production discussed below). Here, the ionic polymer can still be formed on the nanoparticle without disruption of the layers of the nanoparticle.

Surface functionalization of, for example, carbon nanoparticles can be accomplished by the method described by Wu et al., Functionalization of Carbon Nanotubes by an Ionic-Liquid Polymer: Dispersion of Pt and PtRu Nanoparticles on Carbon Nanotubes and Their Electrocatalytic Oxidation of Methanol, 48 Angewandte Chemie, 4751 (2009).

A polymerization initiator can be added to the ionic liquid and nanoparticle composition. The initiator can be thermally labile so that it can form radicals via bond cleavage. Examples of the initiator include organic peroxides or azo compounds. Optionally a solvent can be added to the reaction mixture. The solvent can be a water-miscible or non-miscible solvent.

The ionic polymer formed in the polymerization reaction associates with the nanoparticles. Such association includes covalent bonds between the ionic polymer and atoms of the nanoparticle (e.g., surface atoms of the nanoparticle and can include more than one surface atom), ion-dipole interactions, adhesion of ionic polymers onto the nanoparticle via a π-cation and π-π interactions, and surface adsorption (including chemisorption and physisorption). Due to the distribution of surface charges from the ionic polymer, the nanoparticles are prevented from aggregating. Thus, when placed in a placed in a liquid or solid (or combination of these such as a heterogeneous composition), the ionic polymer coated nanoparticles form a stable suspension in the liquid and are well-dispersed among the components of the liquid or solid. Without wishing to be bound by theory, it is believed that the positive charges of the ionic polymer coated nanoparticles cause Coulombic repulsion among the nanoparticles. Further, the nanoparticles can attract and have affinity for other particles such as polar solvents or polymers. Due to the surface of the nanoparticles having the ionic polymer, the nanoparticles are miscible in both aqueous fluids and oils. As used herein, oils include both oils and nonpolar liquids useful for downhole applications, and that are not aqueous based. Exemplary oils thus include diesel, mineral oil, esters, refinery cuts and blends, alpha-olefins, and the like. Oil-based fluids further include synthetic-based fluids or muds (SBMs) which can contain additional solid additives. Synthetic-based fluids of this type include ethylene-olefin oligomers, fatty acid and/or fatty alcohol esters, ethers, polyethers, paraffinic and aromatic hydrocarbons, alkyl benzenes, terpenes, and the like.

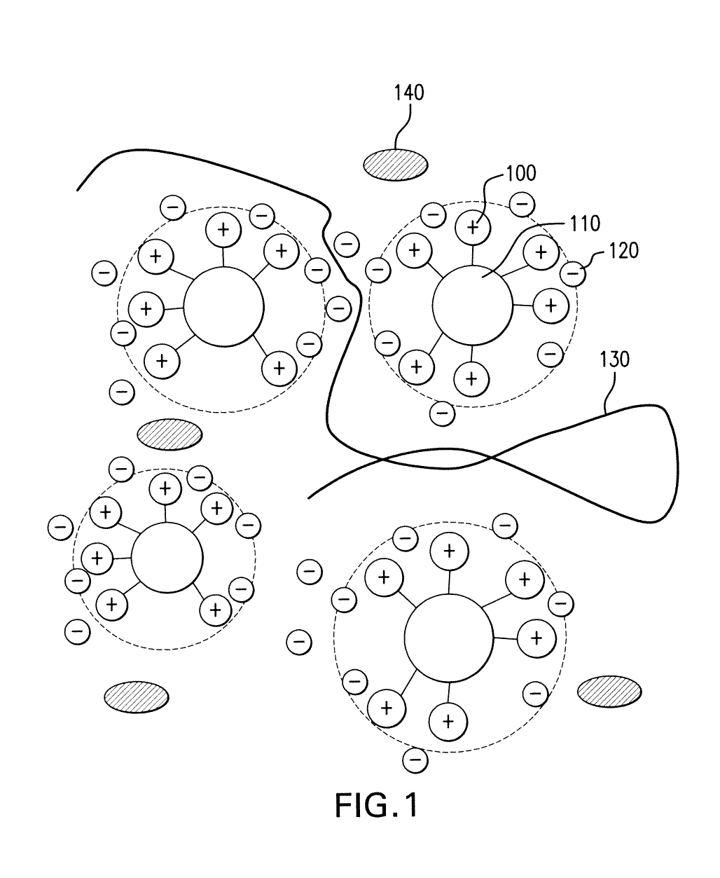

FIG. 1 shows an ionic polymer disposed on a nanoparticle, which is dispersed among a hydrophilic molecule and a hydrophobic molecule. Here, an ionic polymer with cation groups 100 (bonds between the cation groups of the ionic polymer are not shown) is attached to a nanoparticle 110. Anions 120 interact with cation groups 100. The nanoparticles 110 repel one another but are miscible with hydrophobic compounds 130 (e.g., an aliphatic molecule or hydrocarbon polymer) and hydrophilic compounds 140 (e.g., a polar solvent or polar polymer).

The ionic polymer coated nanoparticles have a myriad of uses. In an embodiment, such particles can form emulsions. In another embodiment the particles can be used in a nanocomposite, for example, a layer-by-layer (LbL) coating, coolant, or precursor to a polycrystalline diamond composition (PDC). In the case of the precursor to the PDC, further processing thereof yields a PDC.

In an embodiment, the nanoparticle having the ionic polymer is dispersed in a matrix and/or disposed on a matrix.

According to a non-limiting embodiment, the nanocomposite is the LbL coating, the matrix is a substrate, and the nanoparticle is in a layer disposed on the substrate. In an exemplary embodiment, the layer-by-layer coating includes multiple layers disposed on one another. In the layer-by-layer coating, a nanoparticle layer containing nanoparticles having an ionic polymer is disposed on a substrate, and a binding layer is disposed on the nanoparticle layer. The binding layer contains a polyanion (or alternatively a polycation). The nanoparticle layer and the binding layer are electrostatically attracted to one another. With respect to the substrate, any order of the nanoparticle layer and binding layer can occur. Additionally, more than one layer of each can be present, interrupted by interposing a nanoparticle layer or binding layer, as appropriate, to create alternating layers of nanoparticles, polycations, or polyanions (and any combination comprising at least one of the foregoing).

The positively charged nanoparticles with an anionic shell (see FIG. 1) can be disposed between positively charged layers (e.g., a polycation binding layer or positively charged substrate) or negatively charged layers (e.g., a polyanion binding layer or negatively charged substrate). Moreover, the nanoparticle layer can be disposed at an interface between oppositely charged layers, i.e., a positively charged layer and negatively charged layer. In another embodiment, instead of polycations or polyanions in the binding layer within the LBL coating, the binding layer can include material such as nanoclay, ceramic, semiconductor particles, and the like.

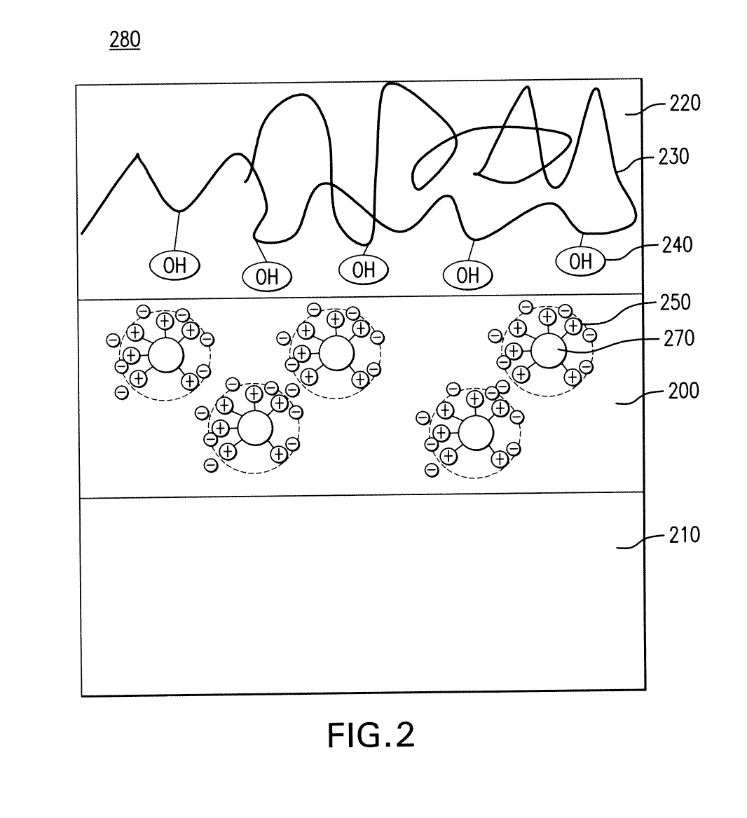

In a specific embodiment, the nanocomposite is the LbL coating, the matrix is a substrate, and the nanoparticle is in a layer disposed on the substrate. In an exemplary embodiment, the layer-by-layer coating includes multiple layers disposed on one another. FIG. 2 shows a cross-section of a layer-by-layer coating. In the layer-by-layer coating 280, a nanoparticle layer 200 containing nanoparticles 270 having an ionic polymer 250 is disposed on a substrate 210, and a polar binding layer 220 is disposed on the nanoparticle layer 200. The polar binding layer 220 contains a polar polymer 230 having polar groups 240. The nanoparticle layer 200 and the polar binding layer 220 are electrostatically attracted to one another by the ionic polymer 250 (of the nanoparticles 270) and polar groups 240 of the polar polymer 230. Although FIG. 2 shows a specific ordering of the layers, it should be understood that any order of the nanoparticle layer and polar binding layer can occur on the substrate and also that more than one layer of each can be present. Further, multiple layers of the nanoparticle layers can be separated by a polar binding layer. Likewise, multiple layers of the polar binding layer can be separated by a nanoparticle layer.

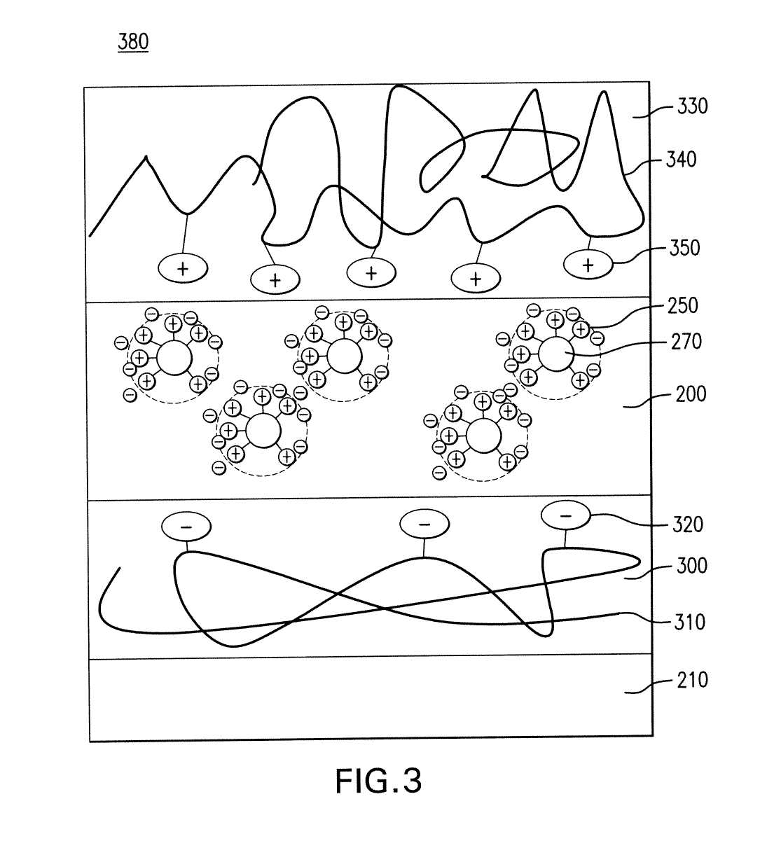

In another embodiment, shown in FIG. 3, LbL coating 380 has nanoparticle layer 200 interposed between a first binding layer 300 and second binding layer 330. The first binding layer 300 has a polyanion 310 with anion groups 320 that are electrostatically bound to nanoparticles 270 of nanoparticle layer 200. The second binding layer 330 has a polycation 340 with cation groups 350.

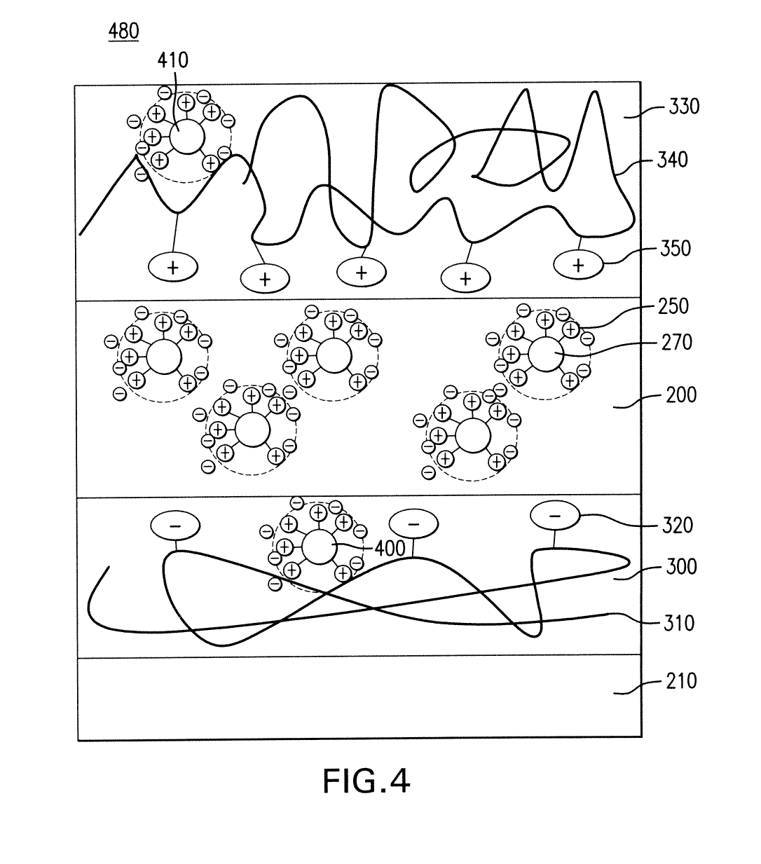

In yet another embodiment, show in FIG. 4, LbL coating 480 has nanoparticles 400 disposed in a first binding layer 300 with a polyanion 310. Nanoparticles 410 are likewise disposed in second binding layer 330 among a polycation 340.

A description of layer-by-layer coatings as well as their formation and use is detailed in U.S. patent application Ser. No. 12/180,748, filed on Jul. 28, 2008, the disclosure of which is incorporated herein by reference in its entirety.

The layer-by-layer coating can be used as a coating for a downhole seal. In an embodiment, the LbL coating is applied to O-ring and back-up ring seals, D-rings, V-rings, T-rings, X-rings, U-cups, chevron seals, lip seals, flat seals, symmetric seals, gaskets, stators, valve seats, tubing, packing elements, wipers, bladders, and other like sealing elements.

According to an embodiment, the seal elements for downhole tools can comprise an LbL coating on the seal substrate to improve various properties of the seal element and/or enhance the useful life of the seal element, and therefore, the useful life of the downhole tools. The LbL coating provides a protective barrier to protect the seal against degradation, swelling, and the like by, for example, blocking downhole fluids (liquid or gas) that diffuse into the polymer matrix of the seal. In an exemplary embodiment, the coating can be effective to improve one or more of the properties of the seal element, including, for example, improvements in chemical resistance, explosive decompression resistance, tensile strength, compressive strength, tear/shear strength, modulus, compression set, thermal resistance, heat/electrical conductivity, and the like. The coating can be conformal (i.e., the coating conforms to the surfaces of a seal element substrate). Moreover, an exemplary coating can be deposited onto the internal surfaces of a stator to reduce the swelling and wear often associated with rubber stators in downhole environments.

In another embodiment, the layer-by-layer (LbL) coating is a coating for an electrical article. Particularly, the layer-by-layer coating is applied to electrical contacts in electromechanical downhole equipment, for example, an electrical submersible pump (ESP). Here, a metallic part of an electromechanical downhole device is coated with an LbL coating to preserve the metallic part in a corrosive environment, including compounds and compositions such as sour gas or sweet gas, which are hydrogen sulfide and/or carbon dioxide containing gases. The LbL coating is a barrier layer disposed on the underlying metallic contact. An electrical junction between electric contacts having an LbL coating (i.e., an LbL coating on the metal contact) disclosed herein is highly conductive due to dispersed nanoparticles having the ionic liquid polymer in the LbL coating. The nanoparticles are conductive, and the ionic liquid polymer generally does not degrade the conductivity of the nanoparticles. In cases where the ionic liquid polymer modifies the electrical conductivity of the nanoparticles, the effect is very small.

The LbL coatings described herein advantageously comprise a layer of nanoparticles coated with an ionic polymer described above. In some embodiments, the LbL coatings can further comprise a binding layer (including, e.g., polyanions, or polycations, a polar binding material, or a combination thereof) to form a bilayer with the nanoparticles. This bilayer of nanoparticles and binding material can be in the form of a thin film on a substrate surface of the substrate. The nanoparticle layers can comprise the same nanoparticles, or they may be different. Likewise, the binding layers can comprise the same binding materials, or they may be different. The number of layers in the LbL coating, as well as the overall coating thickness can depend upon the particular coating application, configuration, substrate composition, component tolerance, and the like. In an exemplary embodiment, the LbL coating can have a thickness effective to provide a barrier that improves the chemical and material properties of the substrate (e.g., a seal element or electric contact), without negatively affecting any critical tolerances for the downhole tool component. Exemplary thicknesses for the LbL coating on the substrate can be from about 10 nm to about 100 μm, specifically about 20 nm to about 500 nm, and more specifically about 50 nm to about 200 nm.

The nanoparticle layer of the thin film LbL coating has a greater surface area than both the binding layer and the substrate surface due to the nano-size and volume of the nanoparticles. The structure of the nanoparticle layer, therefore, can form interfacial interactions with the binding layers, including van der Waals and cross-linking interactions to improve the properties of the substrate, such as chemical resistance. In an embodiment, nanotubes are used in the LbL coating. Here, the length of the nanotubes prevents crack propagation in the layer by forming a molecular bridge between two sides of a crack and preventing further material separation. Moreover, the nanoparticles can be small enough to fill the voids found in substrate elements that liquids and gases could otherwise enter. The LbL coating, therefore, can prevent swelling of, e.g., the seal element caused by fluid absorption in the seal surface. Likewise, the LbL coating can prevent electrochemical corrosion or insulating layer growth on electrical contacts. The nanoparticle layer comprises nanoparticles having a particle size scale in the range of about 0.3 nm to about 500 nm, specifically about 1 nm to about 200 nm, and more specifically about 3 nm to about 50 nm. In an exemplary embodiment, the nanoparticles are nanoclays. Therefore, the thickness of each nanoparticle layer can be about 0.3 nm to about 500 nm, specifically about 0.5 nm to about 200 nm, more specifically about 1 nm to about 50 nm, and even more specifically about 3 nm to about 20 nm.

The binding layer is disposed on a selected one or both sides of the nanoparticle layer to bind the nanoparticles and form the bilayer of the thin film LbL coating. Exemplary materials for forming the binding layer will include those materials having the thermal and chemical resistance properties to withstand the conditions found in harsh environments, such as those found in downhole applications. Moreover, the exemplary materials for the binding layer can separate the nanoparticles enough that they can slide over each other in order to form coating layers. Exemplary binding layer materials can include, without limitation, ionic molecules, such as salts, polymers, oligomers, and the like. The polymer materials can be any long or short-chained polymers (including copolymers, and the like) that have a chemical polarity or charged groups appropriate for bonding with the nanoparticle layer of the LbL coating. An example of such a polymer material can be a polycation, polyanion, or polar polymer. In one embodiment, the polymer can be cross-linked to provide stretchability to the LbL coating in order to accommodate the surface strains typically experienced by a flexible seal element or a thermally expanding metallic electric contact employed in a downhole tool. Exemplary polymers can include thermoplastics, thermosets, and polyelectrolytes (including polyampholytes), such as, without limitation, polycarbonate, poly(acrylic acid), poly(methacrylic acid), polyoxide, polysulfide, polysulfone, fluoropolymers (e.g., polytetrafluoroethylene), polyamide, polyester, polyurethane, polyimide, poly(vinyl acetate), poly(vinyl alcohol), poly(vinyl chloride), poly(vinyl pyridine), poly(vinyl pyrrolidone), epoxies, polyethylene imine, polypropylene imine, polyethylene polyamine, polypropylene polyamine, polyvinylamine, polyallylamine, chitosan, polylysine, protamine sulfate, poly(methylene-co-guanidine)hydrochloride, polyethylenimine-ethoxylated, quaternized polyamide, polydiallyidimethyl ammonium chloride-co-acrylamidem poly(diallyidimethylammonium chloride), poly(vinylbenzyltrimethyl-ammonium), poly(acryloxyethyltrimethyl ammonium chloride), poly(methacryloxy(2-hydroxy)propyltrimethyl ammonium chloride), poly(N-methylvinylpyridine), poly(allylaminehydrochloride), copolymers thereof, and combinations thereof Exemplary polymer binding layer materials can also include elastomers, specifically polar fluoroelastomers. Exemplary fluoroelastomers are copolymers of vinylidene fluoride and hexafluoropropylene and terpolymers of vinylidene fluoride, hexafluoropropylene and tetrafluoroethylene. The fluoroelastomers used in the polymeric layer can be elastomers that comprise vinylidene fluoride units (VF2 or VdF), hexafluoropropylene units (HFP), tetrafluoroethylene units (TFE), chlorotrifluoroethylene (CTFE) units, and/or perfluoro(alkyl vinyl ether) units (PAVE), such as perfluoro(methyl vinyl ether)(PMVE), perfluoro(ethyl vinyl ether)(PEVE), and perfluoro(propyl vinyl ether)(PPVE). These elastomers can be homopolymers or copolymers. Specifically exemplary polymeric layer materials are fluoroelastomers containing vinylidene fluoride units, hexafluoropropylene units, and, optionally, tetrafluoroethylene units and fluoroelastomers containing vinylidene fluoride units, perfluoroalkyl perfluorovinyl ether units, tetrafluoroethylene units, and the like. Exemplary polar fluoroelastomers can include those commercially available from DuPont and Daikin Industries, Ltd. The thickness of each binding layer can be about 1 nm to about 10 μm, specifically about 1 nm to about 500 nm, and more specifically about 10 nm to about 100 nm.

Deposition of the individual layers on the substrate to form the LbL coating, e.g., the seal coating, can comprise any suitable deposition method known to those having skill in the art. Exemplary deposition methods, can include, without limitation, film casting, spin casting, dip coating, spray coating, layer-by-layer build-up techniques, and the like. Such methods can form a coated downhole seal.

In an exemplary embodiment, a seal coating is formed on a surface of a substrate using a layer-by-layer (LbL) technique. The seal coating can be obtained by physical deposition of a binding material (in a layer) and nanoparticles with the ionic polymer coating (in a separate layer) on the substrate. The LbL process involves alternating exposure of an ionized substrate to dilute aqueous solutions of polycations and polyanions or otherwise complementary species. With each exposure, a polyion layer is deposited and surface ionization is reversed, allowing a subsequent complementary layer (e.g., of opposite charge) to be deposited. Smooth and uniform composite films of any thickness and composition can be created to meet a wide variety of applications. Polymers that can be used in formation of film by the LbL process include poly(pyrrole), poly(aniline), poly(2-vinylpyridine), poly(viologen), poly(3,4-ethylene dioxythiophene), poly(styrene sulfonate), poly(8-(4-carboxy-phenoxy)-octyl acrylate), poly(3-(4-pyridyl)-propyl acrylate), poly(vinyl alcohol), poly(2-vinylpyridine), poly(acrylic acid), poly(methyl methacrylate), poly(D,L-lactide), poly(thiophene-3-acetic acid), poly(allylamine hydrochloride), poly(lysine), poly(ethyleneimine), poly (2-acrylamido-2-methyl-l-propane-sulfonic acid), and poly(dimethylsiloxane).

Any suitable deposition techniques can be used in the LbL coating. Exemplary deposition techniques can include, without limitation, dipping a seal element into a coating solution, spraying the seal element with a coating solution, brush coating the seal element with a coating solution, roll coating the seal element with a coating solution, spin casting the seal element with a coating solution, combinations thereof, and the like. A “charged binding material” or a polyionic material refers to a charged polymer material that has a plurality of charged groups in a solution, or a mixture of charged polymers each of which has a plurality of charged groups in a solution. Exemplary charged polymer binding materials include those polar polymers described above for use in the binding layer of the coating.

The layer-by-layer coatings and methods described herein can impart improved chemical resistance, explosive decompression resistance, strength, toughness, wear resistance, thermal resistance, heat/electrical conductivity, and the like, to the seal elements found in a wide variety of downhole tool components and applications. The LbL coatings comprise materials suitable for the severe environmental conditions found in downhole surroundings. The coatings are useful for barrier coating on seal and electrical elements employed in a variety of downhole production equipment, such as tools used for hydrocarbon fluid exploration, drilling, completion, production, reworking, simulation, and the like. Moreover, the LbL coating technique used to deposit the coating on the substrate can impart an LbL coating of varying composition, thickness, or bilayer structure, based on the desired application of the substrate. Even further, the coating can be applied as a film so thin that the critical component tolerances are not affected, while being thick enough to impart the properties described above on the substrate, including electrical conductivity.

In another embodiment, the nanocomposite is a coolant, and the matrix is a downhole fluid comprising a fluid medium. Nanoparticles having an ionic polymer coating described herein are combined with the fluid medium to produce the nanocomposite. The nanoparticles and fluid medium can be combined in various ways, for example, mixing using a commercial blender. Due to the ionic polymer coating on the nanoparticles, the nanoparticles are uniformly dispersed in the fluid medium. The coolant can be used to transfer heat to or from a downhole element. In an embodiment, a method of heat transfer or management includes contacting a downhole fluid comprising a fluid medium and a nanoparticle having an ionic polymer thereon, to a downhole element inserted in a downhole environment.

The fluid medium is an aqueous fluid, an organic fluid, a gas, or a combination comprising at least one of the foregoing. Exemplary fluid media include water, brine, oil, air, an emulsified mixture of one or more of these, ionic liquids such as imidazolium, pyridinium, and cycloalkylammonium salts, and mixtures thereof, or a combination comprising at least one of the foregoing.

In an embodiment, the nanoparticle having the ionic polymer coating is included in the downhole fluid in an amount of about 0.01 to about 50 wt %, in another embodiment, about 0.1 to about 40 wt %, and in another embodiment about 1 to about 30 wt %, based on the total weight of the downhole fluid. The downhole fluid containing the nanoparticle in this amount has greater thermal conductivity than a downhole fluid having the same composition but without the nanoparticle.

The coolant can be injected downhole and circulated to manage heat in the borehole as well as heat generated by various tools used downhole. According to an embodiment, a method of cooling a downhole element includes contacting the downhole fluid comprising the fluid medium and nanoparticles, to a downhole element in a downhole environment, wherein the downhole element has (or is operating at) a higher temperature than the downhole fluid and the downhole fluid absorbs heat from the downhole element.

Additionally, a coolant that is electrically conductive includes nanoparticles with an ionic polymer coating and fluid that is, for example, oil, synthetic oil, diesel fuel, petroleum product, or a combination comprising at least one of the foregoing. Such oil based drilling fluids may cause minimal, if any, damage to a formation, and resistivity measurements can be performed in these oil based fluids due to the conductivity (and dispersion) of the nanoparticles with the ionic polymer coating. Thus, in an embodiment, a method of logging a downhole environment includes disposing a coolant in a borehole, the coolant including nanoparticles having an ionic polymer coating (which is reaction product of an ionic liquid monomer) and a fluid. The fluid contains an oil. The method further includes disposing a resistance device in the downhole environment; and measuring the resistance of the downhole environment using the resistance device to log the downhole environment.

In yet another embodiment, the nanocomposite is a precursor to a polycrystalline diamond composition. Here, the nanoparticles with the ionic polymer described herein are dispersed in a matrix of diamond material. Moreover, the nanoparticle is a metal, and additionally, the metal has a carbon coating thereon. The carbon coating comprises a carbon onion, single walled nanotube, multiwalled nanotube, graphite, graphene, fullerene, nanographite, C1-C40 alkane, C1-C40 alkene, C1-C40 alkyne, C3-C60 arene, or a combination comprising at least one of the following. The ionic polymer coating is disposed directly on the metal core of the nanoparticle, the carbon coating, or a combination comprising at least one of the foregoing.

A description of polycrystalline diamond compositions as well as their formation and use is detailed in U.S. patent application Ser. No. 13/252,551, filed on Oct. 4, 2011, the disclosure of which is incorporated herein by reference in its entirety.

Metal nanoparticles having a carbon coating are combined with the ionic liquid, and the ionic liquid is polymerized into a ionic polymer on the nanoparticles. The ionic polymer attaches to the metal core of the nanoparticles, the carbon coating, or a combination comprising at least one of the foregoing. The metal nanoparticles having the ionic polymer and carbon coating are combined with diamond material to form a precursor to a polycrystalline diamond compact. Further processing of the precursor to the PDC provides a polycrystalline diamond compact. The processing includes a high pressure high temperature (HPHT) process, for example, sintering at a temperature of greater than or equal to about 1000° C. at a pressure greater than or equal to about 5 gigapascals for about 1 second to about 1 hour. Additionally, processing the precursor to the PDC includes catalyzing formation of a polycrystalline diamond by the nanoparticle; and forming interparticle bonds that bridge the diamond material by carbon from the carbon coating to form a PDC, wherein the ionic polymer causes uniform distribution of the nanoparticles in the diamond material matrix.

As used herein, the term “polycrystalline” means a material (e.g., diamond or diamond composite) comprising a plurality of particles (i.e., crystals) that are bonded directly together by interparticle bonds. During the processing, the metal nanoparticles catalyze formation of the polycrystalline diamond, and bonds between the diamond material (i.e., interparticle bonds) are formed by carbon from the carbon coating of the metal nanoparticles. In this way, diamond crystals grow by the accumulation of bridging bonds formed by carbon from the carbon coating bonding with carbon from the diamond material.

The metal nanoparticle can be formed from organometallic compounds such as metallocenes. The metal is supplied by the metal center of the metallocene, and the carbon coating is provided by the carbocyclic components of the metallocenes. Exemplary metallocenes include ferrocene, cobaltocene, nickelocene, ruthenocene, vanadocene, chromocene, decamethylmanganocene, decamethylrhenocene, or a combination of at least one of the foregoing.

The metal nanoparticles having the carbon coating and ionic polymer thereon can be formed from the organometallic material via numerous ways (including pyrolysis, chemical vapor deposition, physical vapor deposition, sintering, and similar processes, or a combination thereof) that release the metal atoms from the ligands in the organometallic material. In an embodiment, an organometallic material, for example, a metallocene, is pyrolized so that the metal atoms from the metallocene form a metal nanoparticle, for example, a cobalt nanoparticle formed from cobaltocene. Carbon from the liberated ligands (cyclopentadienyl rings in the case of cobaltocene) associate with the metal nanoparticle to form a carbon coating on the metal nanoparticle. Pyrolysis of metallocenes can be performed at about 70° C. to about 1500° C. at a pressure of about 0.1 pascals (Pa) to about 200,000 Pa for a time of about 10 microseconds (μs) to about 10 hours.

The carbon coating can contain carbon with sp, sp², sp³ hybridization, or a combination thereof In particular, the carbon coating contains sp² and sp³ hybridized carbon. In another embodiment, the carbon coating contains only sp² carbon. In an embodiment, the carbon coating can be a single layer or multiple layer of carbon on the metal nanoparticle. Further, in the case of multiple layers in the carbon coating, the carbon in each layer can be hybridized differently or the same as another layer. Moreover, a layer may cover the entire surface of the metal nanoparticle, or the metal nanoparticle can be exposed through one or more layers of the carbon coating, including the entire carbon coating.

After formation of the metal nanoparticles having the carbon coating, the ionic polymer (from the ionic liquid) is disposed on the metal nanoparticles as described above. Subsequently, the nanoparticle having the carbon coating and ionic polymer are combined with the matrix (diamond material). The nanoparticles are present in an amount of about 0.1 wt % to about 20 wt %, based on the weight of the diamond material and the nanoparticles (including the carbon coating and ionic polymer).

As mentioned above, the metal nanoparticles having the carbon coating and ionic polymer (from the ionic liquid) are combined with diamond material, and the combination is processed to form the polycrystalline diamond. Additional nano- and/or microparticles and other additives can be added before forming the polycrystalline diamond. Combining can include mixing the components including the diamond material and the metal nanoparticles having the carbon coating with ionic polymer in a solvent to form a suspended mixture. The solvent can be any solvent suitable for forming a suspension of these components and can include deionized water, aqueous solutions having a pH of 2 to 10, water miscible organic solvents such as alcohols including methanol, ethanol, isopropanol, n- and t-butanol, 2-methoxyethanol (methyl cellosolve), 2-ethoxyethanol (ethyl cellosolve), 1-methoxy-2-propanol, dimethylsulfoxide, N,N-dimethylformamide, N,N-dimethylacetamide, N-methylpyrrolidone, gamma-butyrolactone, acetone, cyclohexanone, and the like, or a combination comprising at least one of the foregoing.

A binder may also be included in the slurry, to bind the diamond material and metal nanoparticles having the carbon coating to retain shape during further processing prior to, for example, sintering. Any suitable binder may be used provided the binder does not significantly adversely affect the desired properties of the polycrystalline diamond or adversely affect the diamond material or the metallic nanoparticles having the carbon coating. Binders may comprise, for example, a polymeric material such as a polyacrylate, or polyvinylbutyral, an organic material such as a cellulosic material, or the like. It will be understood that these binders are exemplary and are not limited to these.

In an embodiment, mixing comprises slurrying the diamond material and metal nanoparticles having the carbon coating and ionic polymer to form a uniform suspension. Mixing may further comprise slurrying a nanoparticle or a microparticle, which is not identical to the metal nanoparticles having the carbon coating with ionic polymer or the diamond material, with the other components. As used herein, “uniform” means that the composition of the slurry, analyzed at random locations in the mixing vessel, has less than 5% variation in solids content, specifically less than 2% variation in solids content, and more specifically less than 1% variation in solids content, as determined by drying a sample of the slurry. In an embodiment, the suspension has a total solids content (diamond material, metal nanoparticles having the carbon coating and ionic polymer, and any other additives) of 0.5 to 95 wt. %, specifically 1 to 90 wt. %, more specifically 10 to 80 wt. %, and still more specifically 10 to 50 wt. %, based on the total weight of the slurry.

This suspended mixture is then heated to remove the solvent under elevated temperature. Thermally treating to remove the solvent can be carried out by subjecting the mixture to a temperature of about 50° C. to about 800° C., specifically about 150° C. to about 750° C. The thermal treating may be carried out for at least about 10 minutes, more specifically at least about 60 minutes, prior to annealing. The thermal treatment may be carried out under vacuum or at ambient pressure. As a result, a dispersion of the metal nanoparticles having the carbon coating with ionic polymer in the diamond material is formed.

Before removal of the solvent, the suspended mixture can be treated to establish a concentration gradient of the metal nanoparticles having the carbon coating with ionic polymer in the diamond material. Then the solvent is removed as above. In this manner, a dispersion is formed wherein the diamond material is in a concentration gradient of the metal nanoparticles having the carbon coating with ionic polymer.

In an embodiment, the metal nanoparticles having the carbon coating and ionic polymer are present in an amount of about 0.001 wt. % to about 40 wt. %, specifically about 0.01 wt. % to about 30 wt. %, and more specifically about 0.1 wt. % to about 20 wt. %, based on the weight of the diamond material and the metal nanoparticles having the carbon coating with ionic polymer.

The polycrystalline diamond is formed by processing the polycrystalline diamond precursors (diamond material, metal nanoparticles having the carbon coating and ionic polymer, and optional nanoparticles and/or microparticles) under conditions of heating and pressure.

Examples of the diamond material include, for example, nanodiamonds and microdiamonds. The nanodiamonds and microdiamonds may be functionalized to aid dispersion with the metal nanoparticle having the carbon coating with the ionic polymer or to aid in forming interparticle bonds between the diamond material particles. The functionalized nanodiamond includes functional groups comprising alkyl, alkenyl, alkynyl, carboxyl, hydroxyl, amino, amido, epoxy, keto, alkoxy, ether, ester, lactones, metallic groups, organometallic groups, polymeric groups, ionic groups, or a combination comprising at least one of the foregoing. Alternatively, or in addition, the microdiamond can be functionalized with the foregoing functional groups. Microdiamonds are diamond particles having an average particle size of greater than or equal to 1 micrometer (μm). In an embodiment, the average particle size of the microdiamond is about 1 μm to about 250 μm, specifically about 2 μm to about 100 μm, and more specifically about 1 μm to about 50 μm. Further, the nanodiamonds and microdiamonds can be coated with sp² carbon to aid in forming the interpaticle bonds. Nanodiamonds and microdiamonds that can be used are described in U.S. patent application Ser. No. 13/077,426, the disclosure of which is incorporated herein by reference in its entirety.

After the diamond material and metal nanoparticles having the carbon coating with ionic polymer are combined, the method further includes processing the diamond material and the metal nanoparticles having the carbon coating with ionic polymer to form polycrystalline diamond. During processing, the metal nanoparticles catalyze formation of the polycrystalline diamond by catalyzing bond formation between carbon in the carbon coating and carbon in the diamond material so that carbon-carbon bonds are formed that bridge the diamond material. Moreover, the high degree of dispersion of the metal nanoparticles due to the ionic polymer provides polycrystalline diamond with improved properties. Consequently, polycrystalline diamond is made by formation of these interparticle bonds using sp² carbon from the carbon coating. Thus, the polycrystalline diamond is catalytically (the metal nanoparticles are a catalyst) produced by subjecting diamond crystals in the diamond material to sufficiently high pressure and high temperatures so that interparticle bonding occurs between adjacent diamond crystals (of the diamond material) via carbon from the carbon coating.

As disclosed herein, “processing” means sintering the components of the polycrystalline diamond with interparticle bond formation and phase transformation of non-diamond lattice interstitial regions. Such a process is referred to herein as a high-pressure high temperature (HPHT) process, in which interparticle bonds are formed between the diamond material. Such bonds may be covalent, dispersive including van der Waals, or other bonds. Specifically, the interparticle bonds include covalent carbon-carbon bonds, and in particular sp³ carbon-carbon single bonds as found in a diamond lattice, sufficient to provide the hardness and fracture resistance disclosed herein. In an HPHT process, it is believed that component phases of the diamond material undergo a phase change to form a diamond lattice (tetrahedral carbon) structure, and in particular, any graphitic phase (such as, e.g., that of the carbon coating that can include a carbon onion and or any amorphous carbon phase present in the carbon coating) can, in principle, undergo such a phase change and structural transformation from a delocalized sp² hybridized system (a delocalized it-system) as found in the graphitic (i.e., non-diamond) phase(s), to an sp³ hybridized diamond lattice.

In an embodiment, heating to effect sintering is carried out at a temperature of greater than or equal to about 1,000° C., and specifically greater than or equal to about 1,200° C. In an embodiment, the temperature used may be from about 1,200° C. to about 1,700° C., specifically from about 1,300° C. to about 1,650° C. The pressure used in processing may be greater than or equal to about 5.0 gigapascals (GPa), specifically greater than or equal to about 6.0 GPa, and more specifically greater than or equal to about 7.5 GPa. Processing near the peak temperature may be carried out for 1 second to 1 hour, specifically for 1 second to 10 minutes, and still more specifically for 1 second to 5 minutes.

Thus, in an embodiment, processing further comprises sintering by subjecting the mixture to a pressure greater than about 5.0 GPa and a temperature greater than about 1,400° C., for a time of about 1 second to about 1 hour.

A polycrystalline diamond prepared by methods described above may be a superabrasive for use in an article such as a cutting tool, such as a drill bit for an earth-boring apparatus. As used herein, the term “drill bit” refers to and includes any type of bit or tool used for drilling during the formation or enlargement of a wellbore and includes, for example, rotary drill bits, percussion bits, core bits, eccentric bits, bicenter bits, reamers, expandable reamers, mills, drag bits, roller cone bits, hybrid bits, and other drilling bits and tools known in the art.

In an embodiment, a method of making a superabrasive article (e.g., a drill bit), comprising forming a superabrasive polycrystalline diamond compact in an HPHT process by combining diamond material and metal nanoparticles having a carbon coating and ionic polymer (which is a reaction product of polymerizing an ionic liquid); and combining the polycrystalline diamond with a support.

In another embodiment, a superabrasive article (e.g., a cutting tool) comprises a polycrystalline diamond compact comprising a reaction product of a diamond material and metal nanoparticles having a carbon coating and ionic polymer (which is a reaction product from polymerizing an ionic liquid); and a ceramic substrate bonded to the polycrystalline diamond compact, wherein the metal nanoparticles catalyze formation of polycrystalline diamond in the polycrystalline diamond compact, carbon from the carbon coating forms bonds that bridge the diamond material, and the ionic polymer uniformly disperses the nanoparticles in the diamond material.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A nanocomposite comprising:
a matrix; and
a nanoparticle comprising an ionic polymer disposed on the surface of the nanoparticle, the nanoparticle being dispersed in and/or disposed on the matrix.

2. The nanocomposite of claim 1, wherein the ionic polymer comprises a reaction product of an ionic liquid which comprises a cation and an anion.

3. The nanocomposite of claim 2, wherein the ionic liquid further comprises a polymerizable group.

4. The nanocomposite of claim 3, wherein the polymerizable group includes an α,β-unsaturated carbonyl group, α,β-unsaturated nitrile group, alkenyl group, alkynyl group, vinyl carboxylate ester group, carboxyl group, carbonyl group, epoxy group, isocyanate group, hydroxyl group, amide group, amino group, ester group, formyl group, nitrile group, nitro group, or a combination comprising at least one of the foregoing.

5. The nanocomposite of claim 2, wherein the cation is imidazolium, pyrazolium, pyridinium, ammonium, pyrrolidinium, sulfonium, phosphonium, morpholinium, derivatives thereof, or a combination comprising at least one of the foregoing.

6. The nanocomposite of claim 2, wherein the anion is halide, tetrachloroaluminate, hexafluorophosphate, hexafluoroarsenate, tetrafluroborate, triflate, mesylate, dicyanamide, thiocyanate, alkylsulfate, tosylate, bis(trifluoromethyl-sulfonyl)imide, methanesulfate, or a combination comprising at least one of the foregoing.

7. The nanocomposite of claim 2, wherein the ionic liquid comprises 3-ethyl-1-vinylimidazlium tetrafluoroborate, 1-methyl-3-vinylimidazolium, 1-isobutenyl-3-methylimidazolium tetrafluoroborate, 1-allyl-3-methylimidazolium bis(trifluoromethylsulfonyl)imide, 1-allyl-3-methylimidazolium bromide, 1,3-bis(cyanomethyl)imidazolium bis(trifluoromethylsulfonyl)imide, 1-ethyl-nicotinic acid ethyl ester ethylsulfate, 1-butyl-nicotinic acid butyl ester bis[(trifluoromethyl)sulfonyl]imide, 1-(3-cyanoprpoyl)-3-methylimidazolium bis(trifluoromethylsulfonyl)amide, 1,3-diallylimidazolium bis(trifluoromethylsulfonyl)imide, ethyl-dimethyl-(cyanomethyl)ammonium bis(trifluoromethylsulfonyl)imide, 3-[4-(acryloyloxy)butyl]-1-methyl-1H-imidazol-3-ium hexafluorophosphate, 1-methyl-3-{3-[(2-methylacryloyl)oxy]propyl}-1H-imidazol-3-ium bromide, and 3 -ethenyl-1-ethyl-1H-imidazol-3-ium bis(trifluoromethylsulfonyl)imide, or a combination comprising at least one of the foregoing.

8. The nanocomposite of claim 1, wherein the nanoparticle is a nanotube, fullerene, nanowire, nanodot, nanorod, graphene, nanographite, metal, metal oxide, nanodiamond, polysilsesquioxane, inorganic nanoparticle, nanoclay, metal nanoparticle, or a combination comprising at least one of the foregoing.

9. The nanocomposite of claim 1, wherein the nanocomposite is a layer-by-layer (LbL) coating, coolant, or precursor to polycrystalline diamond composition (PDC).

10. The nanocomposite of claim 9, wherein nanocomposite is the LbL coating, the matrix is a substrate, and the nanoparticle is in a layer disposed on the substrate.

11. The nanocomposite of claim 10, wherein the LbL coating further comprises a binding layer disposed on the layer which includes the nanoparticle, the binding layer includes a polar binding layer, charged binding layer, or a combination thereof.

12. The nanocomposite of claim 11, wherein the binding layer comprises an ionic molecule, an oligomer, a polymer, a nanoparticle, a charged nanoparticle, or a combination comprising at least one of the foregoing.

13. The nanocomposite of claim 12, wherein the binding layer has a thickness of about 1 nanometer to about 500 nanometers.

14. The nanocomposite of claim 11, wherein the layer which includes the nanoparticle has a thickness of about 1 nanometer to about 50 nanometers.

15. The nanocomposite of claim 9, wherein downhole nanocomposite is the coolant, and the matrix is a downhole fluid comprising a fluid medium.

16. The nanocomposite of claim 15, wherein the fluid medium is an aqueous fluid, an organic fluid, a gas, an ionic liquid, or a combination comprising at least one of the foregoing.

17. The nanocomposite of claim 16, wherein the nanoparticle is included in the downhole fluid in an amount of about 0.01 wt % to about 50 wt %, based on the total weight of the downhole fluid.

18. The nanocomposite of claim 9, wherein the nanocomposite is the precursor to PDC, the matrix is a diamond material, and the nanoparticle is the metal.

19. The nanocomposite of claim 18, wherein the metal has a carbon coating which comprises a carbon onion, single walled nanotube, multiwalled nanotube, graphite, graphene, fullerene, nanographite, C1-C40 alkane, C1-C40 alkene, C1-C40 alkyne, C3-C60 arene, or a combination comprising at least one of the following.

20. The nanocomposite of claim 19, wherein the nanoparticle having the carbon coating are present in an amount of about 0.1 wt. % to about 20 wt. %, based on the weight of the diamond material and the nanoparticles having the carbon coating.

21. A method of making a nanocomposite, comprising:
combining a nanoparticle and an ionic liquid;
polymerizing the ionic liquid to form an ionic polymer;
disposing the ionic polymer on the nanoparticle; and
combining the nanoparticle with the ionic polymer and a matrix to form the nanocomposite.

22. The method of claim 21, wherein the nanocomposite is a layer-by-layer (LbL) coating, coolant, or precursor to polycrystalline diamond composition (PDC).

23. The method of claim 22, wherein the nanocomposite is the LbL coating, the matrix is a substrate, and combining the nanoparticle with the ionic polymer and the matrix comprises disposing the nanoparticle with the ionic polymer in a layer on the substrate.

24. The method of claim 23, further comprising disposing a binding layer on the layer which includes the nanoparticle, the binding layer being a polar binding layer, charged binding layer, or a combination thereof.

25. The method of claim 24, wherein the binding layer is a fluoroelastomer, wherein the fluoroelastomer comprises a copolymer of vinylidene fluoride and hexafluoropropylene, terpolymers of vinylidene fluoride, hexafluoropropylene and tetrafluoroethylene, or a combination comprising at least one of the foregoing.

26. The method of claim 22, wherein the nanocomposite is the coolant, and the matrix is a downhole fluid comprising a fluid medium.

27. The method of claim 26, wherein the fluid medium is water, brine, oil, synthetic oil, diesel fuel, petroleum product, air, an emulsified mixture of one or more of these, or a combination comprising at least one of the foregoing.

28. The method of claim 22, wherein the nanocomposite is the precursor to PDC, the matrix is a diamond material, the nanoparticle is the metal, and the nanoparticle includes a carbon coating.

29. The method of claim 28, further comprising processing the precursor to a polycrystalline diamond composition, including:
catalyzing formation of a polycrystalline diamond by the nanoparticle; and
forming interparticle bonds that bridge the diamond material by carbon from the carbon coating to form a PDC.

30. The method of claim 29, wherein processing the diamond material and the nanoparticle comprises sintering at a temperature of greater than or equal to about 1000° C. at a pressure greater than or equal to about 5 gigapascals for about 1 second to about 1 hour.
